(19) United States
(12) Patent Application Publication
(10) Pub. No.: US 2018/0113872 A1
(43) Pub. Date: Apr. 26, 2018

(54) AUTOMATED PACKAGING AND DELIVERY OF LIFE CYCLE DATA

(71) Applicant: Simmonds Precision Products, Inc., Vergennes, VT (US)

(72) Inventor: Keith Roseberry, Wake Forest, NC (US)

(21) Appl. No.: 15/332,176

(22) Filed: Oct. 24, 2016

(51) Int. Cl. G06F 17/30

(52) U.S. Cl. CPC G06F 17/30082; G06F 17/30144

(57) ABSTRACT

A system and method for automatically retrieving life cycle data of a product includes a database computer and a data management computer. The database computer is configured to store a life cycle model for the product. The data management computer is configured to generate a file container. The file container includes at least one release set and at least one release record for each of the at least one release set. The data management computer is configured to automatically retrieve the at least one release set and the at least one release record from the life cycle model on the database computer.

### BACKGROUND

The present invention relates generally to data models, and in particular to a system and method for electronically storing a life cycle model of a product.

Products, particularly those that require certification prior to commercial use, may include a plethora of life cycle data that is accumulated over the span of production. Records related to engineering product development that are indicative of this life cycle data may be stored in various forms, both physical and electronic, in several different storage mechanisms, from file cabinets to computer systems. The organization of this life cycle data is often haphazard and disorganized which can lead to significant search times, lost information and eventual rework to reconstruct data that cannot be found. It is desirable to provide a storage architecture that facilitates fast, efficient and complete retrieval of life cycle data for a product.

### SUMMARY

A method of automatically retrieving life cycle data of a product includes generating, by a data management computer, a file container; retrieving, by the data management computer, at least one release set from a life cycle model stored on a database computer; retrieving, by the data management computer, at least one release record for each of the at least one release set, wherein each of the at least one release record are part of the life cycle model and stored in the database computer; and adding, by the data management computer, each of the at least one release set and each of the at least one release record to the file container.

A system for automatically retrieving life cycle data of a product includes a database computer and a data management computer. The database computer is configured to store a life cycle model for the product. The data management computer is configured to generate a file container. The file container includes at least one release set and at least one release record for each of the at least one release set. The data management computer is configured to automatically retrieve the at least one release set and the at least one release record from the life cycle model on the database computer.

### BRIEF DESCRIPTION OF THE DRAWINGS

FIG. 1 is a diagram illustrating a system for storing and retrieving data from a life cycle model.

FIG. 2 is a chart illustrating a life cycle model storage architecture.

FIG. 3 is a chart illustrating a portion of a life cycle model.

FIG. 4 is a chart illustrating a file container generated with files from a life cycle model.

FIG. 5 is a flowchart illustrating a method of automatically retrieving data from a life cycle model and building a file container.

### DETAILED DESCRIPTION

A lifecycle model is disclosed herein that is implemented to organize and provide efficient retrieval of information regarding a product's life cycle. The lifecycle model may be implemented using a database, for example. The lifecycle may include a plurality of records that include information regarding the life cycle of the product or the product itself. The life cycle model may also include a plurality of linkage records stored in the database that are indicative of links between two or more of the plurality of records. Data regarding the life cycle of the product may be retrieved based upon the plurality of records, the plurality of linkage records, or both. The data may be automatically retrieved and organized into a file container, for example, by a data management computer. This way, data may be retrieved regarding the life of the product in an efficient and complete manner.

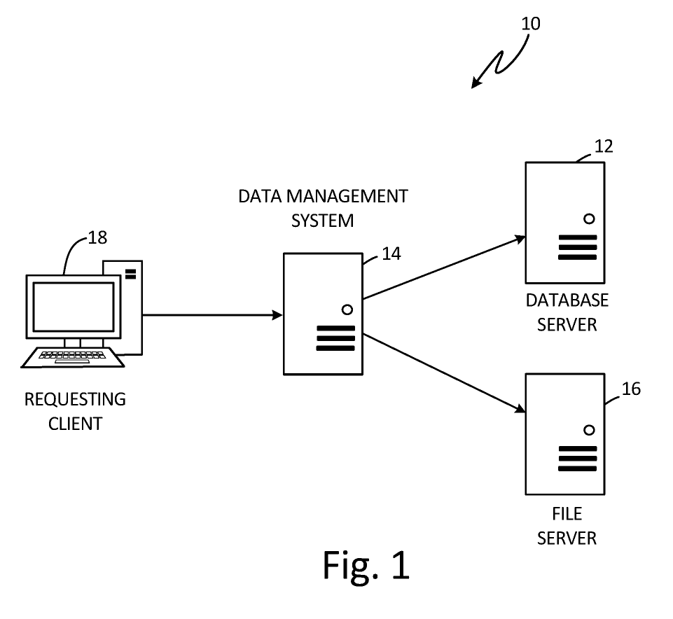

FIG. 1 is a diagram illustrating system 10 for storing and retrieving data from a life cycle reference model. System 10 includes database server 12, data management system 14, file server 16 and requesting client 18. Database server 12, data management system 14 and file server 16 may be implemented as any type of computer system capable of storing data and/or executing software instructions. For example, data management system 14 may include a microprocessor capable of executing software instructions to extract data stored by database server 12. Data management system 14 may also be configured transfer files obtained from database server 12 to file server 16 for storage. Requesting client 18 may be any computer system capable of communicating with data management system 14 and an end user such as a customer, for example. Requesting client 18 may include a user interface, for example, capable of displaying data retrieved from database server 12 and/or file server 16. Requesting client 18 may also be configured to receive input from the customer or another other user. This user input may be indicative of files for retrieval from database server 12.

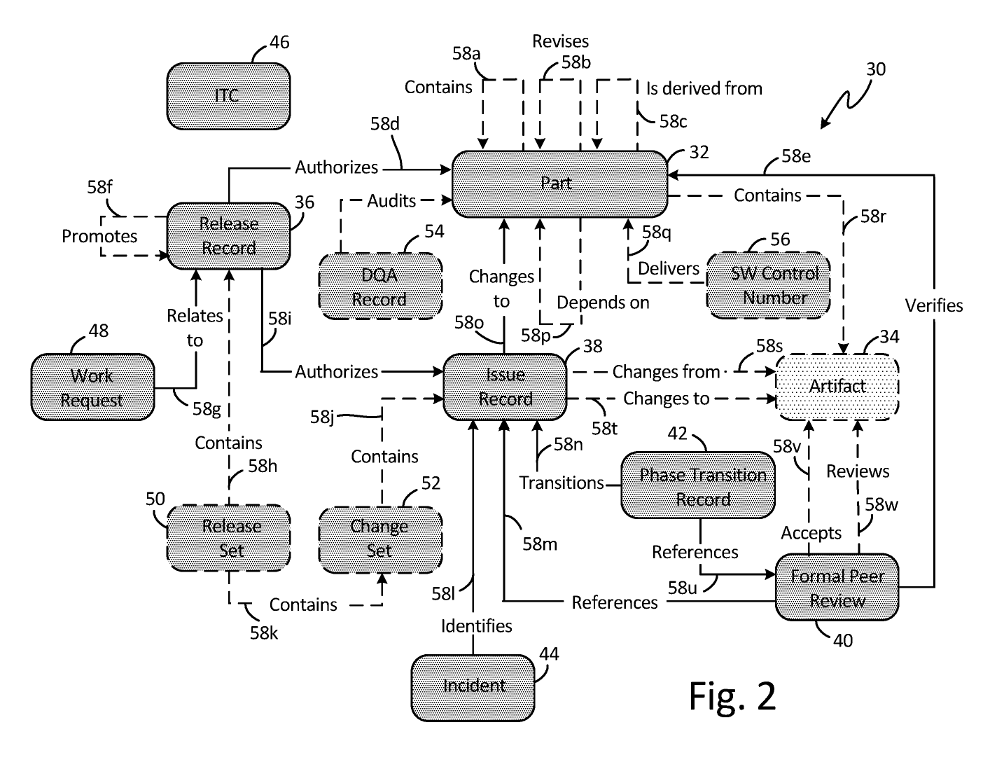

With continued reference to FIG. 1, FIG. 2 is a chart illustrating a storage architecture for life cycle model 30. Life cycle model 30 includes part 32, artifact 34, release record 36, issue record 38, formal peer review 40, phase transition record 42, incident 44, international trade compliance (ITC) record 46, work request 48, release set 50, change set 52, design quality assurance (DQA), software (SW) control number 56 and linkage records 58a-58w. For the embodiment illustrated in FIG. 2, solid lines illustrate required portions of the storage architecture for life cycle model 30 while dashed lines illustrate optional portions of the storage architecture. While illustrated for a software product, life cycle model 30 may be implemented for any product including, but not limited to, software and hardware products. For example, the product may be software developed for a health monitoring unit (HMU) of an aircraft.

Each block and each linkage record 58a-58w shown in FIG. 2 may represent a data element stored in database server 12. Database server 12 may include a microprocessor and a non-volatile memory, for example, configured to implement any database architecture. Records, such as release record 36, issue record 38, and others illustrated in FIG. 2, may be linked to one another using linkage records 58a-58w. Linkage records 58a-58w provide an efficient way to obtain records that are related to one another. For example, the life cycle of a product may include a plurality of release records 36 that each relate to a plurality of parts 32. By using linkage records 58d, each part 32 that relates to a respective release record 36 may be quickly and completely obtained. Linkage records 58a-58w may include meta data, for example, that indicates each record within life cycle model 30 that the respective linkage record 58a-58w references. Linkage records 58a-58w may also include data descriptive of the link between the records. This data is illustrated in FIG. 2. For example, linkage record 58d may indicate that the link represents an authorization from a release record 36 for a respective part 32.

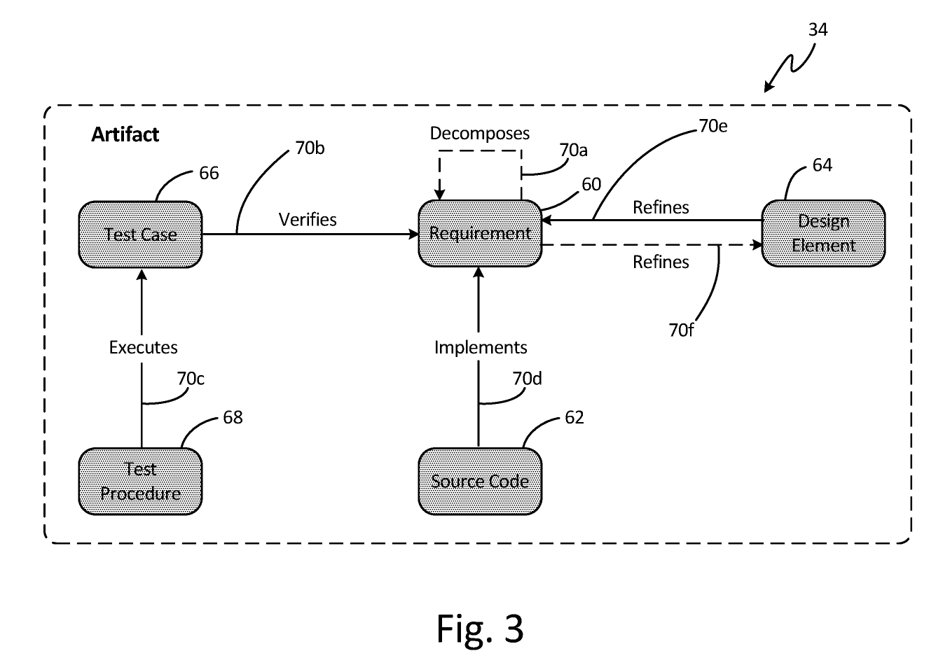

With continued reference to FIGS. 1 and 2, FIG. 3 is a block diagram illustrating artifact 34 of life cycle model 30. Artifact 54 includes requirement 60, source code 62, design element 64, test case 66, test procedure 68 and linkage records 70a-70f. Any block illustrated in FIG. 3 may be interchanged with artifact 34 of FIG. 2. Each block and each linkage record 70a-70f shown in FIG. 3 may represent a data element stored in database server 12. Linkage records 70a-70f may be implemented in the same manner as those illustrated in FIG. 2. Each record illustrated in FIGS. 2 and 3 may be implemented and stored in a similar manner and may also include an associated workflow. These workflows may include dependencies, for example, that ensure the integrity of each record.

In an example embodiment, the first step to populating life cycle model 30 may be to generate part record 32. Part record 32 may represent the product itself, or a representation of the product such as, for example, a requirements document for a software product or a bill of materials for a hardware product. Artifact 34 may then be created from part record 32 and linked to part-record 32 by linkage record 58r. Linkage record 58r references part record 32 and artifact 34 and indicates, for example, that part record 32 contains artifact 34.

Artifact 34 may go through a decomposition process to refine the requirements from a requirements document of part record 32, for example. This process may proceed to a point where design elements 64 and source code 62 may be generated based upon requirements 60. Linkages 70e and 70f may be utilized to identify that a design element 64 is a refinement of requirement 60, which may be a master requirement, for example. Multiple requirements 60 may be linked to one another in a decomposition manner, using linkage records 70a, to indicate that lower level requirements are decomposed from higher level requirements. Requirements 60 and design elements 64 may be utilized to develop source code 62. Source code 62 may be linked by linkage record 70d to the requirements 60 to indicate that this particular source code 62 implements particular requirements 60. For example, there may be many linkage records 70d for a single source code 62 that are utilized to link to all requirements 60 that source code 62 implements.

Test cases 66 may then be developed to test requirements 60. Test procedures 68 may be developed to test requirements 60 by executing cases 66. Each test procedure 68 may link to all test cases 66 for which the respective test procedure 68 executes using linkage records 70c. Linkage records 70b are utilized to reference each requirement 60 that the respective test case 66 verifies. While illustrated as source code 62, a computer-aided design (CAD) for a hardware product, for example, may be utilized in place of source code 62.

While requirements 60 are being developed and tested, the product may also be going through phase transitions and peer reviews, represented by phase transition record 42 and formal peer review 40. Each of requirements 60 may need to go through a peer review. The peer review, represented by formal peer review 40, may be linked to the requirements 60 by linkage records 58v and 58w to indicate that a peer review has been performed for a specific version of a requirement 60. Peer review may be performed for all artifacts 34.

A phase transition may be performed when all requirements 60 and have gone through a peer review, for example. Requirements 60 are accepted and the product life cycle transitions into, for example, a design phase. Phase transition record 42 logs the transition from, for example, the requirements phase to the design phase, or any other phase transition. Phase transition 42 may comprise a checklist or other record that indicates that all of the information and data needed to begin the design phase, for example, has been obtained. Phase transition record 42 may reference and link to those data items in database server 12 and/or file server 16. For example, for a software product, approved system requirements may be needed in order to enter the software requirements phase. Phase transition record 42 may identify and link to specific system requirements 60 that have been reviewed and approved by a systems engineering team, for example, that will then be decomposed into appropriate software requirements.

During integration of a product (software and hardware), incidents 44 may be identified with the product. Incidents 44 may be any issue, problem or other anomalous occurrence associated with the product, such as a bug in the source code for software products or a structural integrity problem for a hardware product, for example. If incident 44 is validated, issue record 38 may invoke a change cycle for any previous artifacts 34 and initiate a new cycle. If incident 44 is determined to be invalid, no change may be generated. At the end of a life cycle, all issue records 38 are closed, all requirements 60 are approved and all source code 62 is tested. At this time, a release is formed and represented by release record 36. A release may be, for example, a build of the product delivered to a customer or an integration lab. Release record 36 captures this information and authorizes parts which may be source code, binary information, or any other data that needs to be delivered for a software product.

Release set 50 and change set 52 may be utilized to group information in order to better organize the information and make the data more manageable. For example, release set 50 may include several release records 36. This relationship may be indicated by linkage records 58h. Change sets 52 may group a set of issue records 38, which may be indicated by linkage records 58j. Some products may require certification prior to commercial use. ITC record 46, or another compliance record, may be used to identify the existence of technical data, the jurisdiction of the technical data (e.g., a state department), and a classification of the technical data (e.g., Export Administration Regulation (EAR), Export Control Classification Number (ECCN) or other). ITC record 46 may apply to all data stored within model 30 for a respective product.

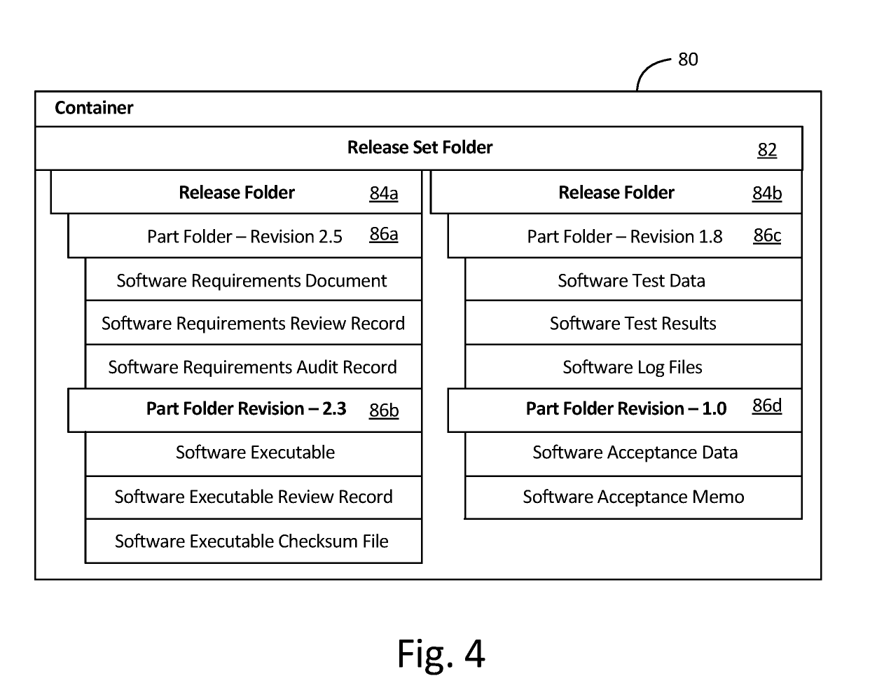

FIG. 4 is a chart illustrating file container 80 generated with files from a life cycle model 30. For customers of a product, it may be desirable to request and obtain data regarding multiple releases of that product. Additionally, for trade commissions, it may be desirable to request a great amount of life cycle data in order to facilitate certification of the product, for example. To facilitate this, data may be automatically gathered and placed into container 80, which includes release set folder 82, release folders 84a and 84b, and part folders 86a-86d. Each part folder 86a-86d includes part data for the specific part revision. While illustrated with specific files and file structure in FIG. 4, file container 80 may be configured in any way.

Data management system 14 may be configured to generate file container 80, for example. A request from a customer may be input into requesting client 18. This request may be communicated to data management system 14 which may generate the initial file structure for container 80. Data management system 14 may then populate container 80 with files specified by requesting client 18. These files may be in any format including, but not limited to, word processing files, binary files, customer specific formats, or any other file type. The file folders may include meta data describing the releases, parts, and data populated within the folders of container 80. The files may be obtained from life cycle model 30 on database server 12. Once container 80 is complete, container 80 may be stored on file server 16, or may be delivered to the customer through requesting client 18. Any computer system connected to, and with permission to access, file server 16 may be utilized to access the completed container 80.

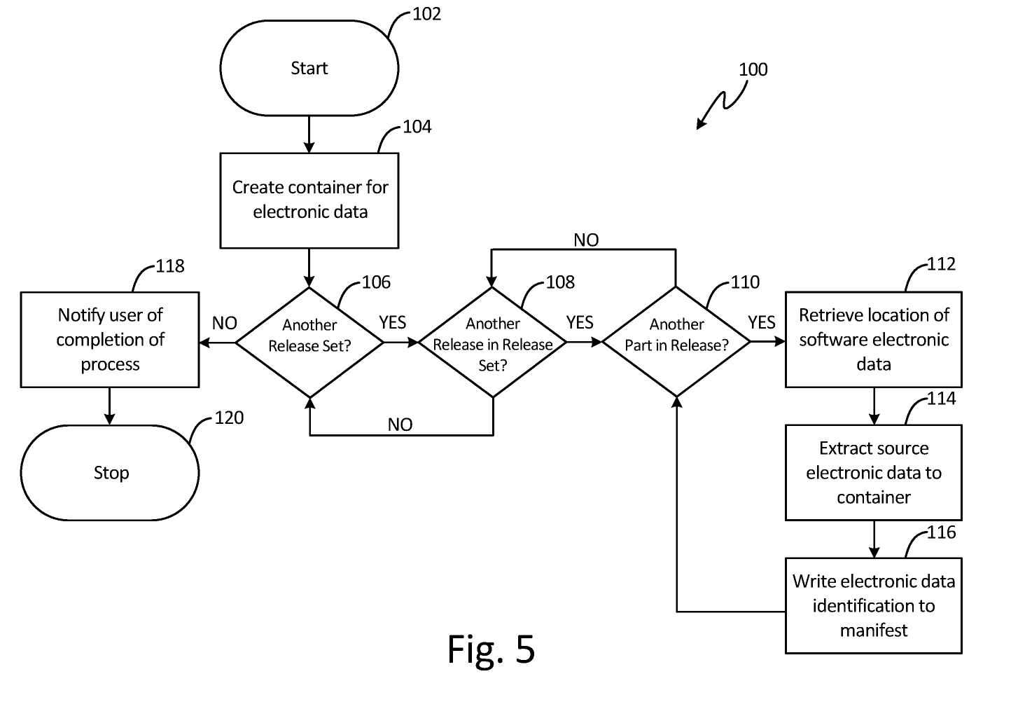

FIG. 5 is a flowchart illustrating method 100 of automatically retrieving data from life cycle model 30. Method 100 begins at step 102. Step 102 may be initiated by a customer, for example, through requesting client 18. At step 104, container 80 is created by data management system 14, for example. At step 106, it is determined if any further release sets 50 remain for container 80. This may be accomplished by querying life cycle model 30 for each requested release set 50. Container 80 may include as many release sets 50 as desired by the customer. If any release sets 50 remain for container 80, method 100 proceeds to step 108. If no release sets remain, method 100 proceeds to step 118. Release sets 50 may be stored in container 80 as a release set folder 82. Release set folder 82 may include meta data, for example, indicative of properties of release set 50.

Each release set folder 82 may be populated with release records 36. There may be any number of release records 36 for a given release set 50. In some cases, a customer may specify specific release records 36 desired for each release set 50. Each release record 36 may have a release folder 84a and 84b as a sub-folder under a respective release set folder 82. At step 108, it is determined if any release records 36 remain for the current release set 50. This may be accomplished by querying life cycle model 30 for each linkage record 56h that references the respective release set 50. If any further release records 36 remain, method 100 proceeds to step 110, otherwise method 100 returns to step 106.

Each release folder 84a and 84b may be populated with part records 32. Each release folder 84a and 84b may include meta data, for example, indicative of properties of the respective release record 36. In some cases, a customer may specify specific part records 32 for a respective release record 36. Each part record 32 may have a part folder 86a-86d as a sub-folder under a respective release folder 84a and 84b. At step 110, it is determined if any part records 32 remain for a respective release record 36. This may be accomplished by querying life cycle model 30 for each linkage record 56d that references the respective release record 36. If any further part records 32 remain, method 100 proceeds to step 112, otherwise method 100 returns to step 108.

Each part folder 86a-86d may be populated with product data that relates to the respective part record 32. Each part folder 86a-86d may include meta data, for example, indicative of properties of the respective part record 32. In some cases, a customer may specify specific product data desired for a respective part record 32. In other cases, all product data may be included for a respective part record 32. At step 112, data management server 14 retrieves the location of electronic data for the respective part records 32. This may be accomplished by querying life cycle model 30 for linkage records 58r, for example, that reference part record 32. At step 114, the electronic data is extracted from the location determined at step 112 and added to the respective part folder 86a-86d within container 80. At step 116, identification of the data is written to the respective part folder 86a-86d to provide identification of the respective data for the requesting customer.

Once container 80 is complete and all data has been written to file server 16, a notification may be provided to the customer or other user at step 118. The customer or other user may then retrieve container 80 through requesting client 18 or any other client computer connected to file server 16. At step 120, method 100 is complete and container 80 is stored on file server 16. Other customers or users may then request previously generated containers 80 or new containers 80.

### Discussion of Possible Embodiments

The following are non-exclusive descriptions of possible embodiments of the present invention.

A method of automatically retrieving life cycle data of a product includes generating, by a data management computer, a file container; retrieving, by the data management computer, at least one release set from a life cycle model stored on a database computer; retrieving, by the data management computer, at least one release record for each of the at least one release set, wherein each of the at least one release record are part of the life cycle model and stored in the database computer; and adding, by the data management computer, each of the at least one release set and each of the at least one release record to the file container.

The method of the preceding paragraph can optionally include, additionally and/or alternatively, any one or more of the following features, configurations, operations, and/or additional components:

A further embodiment of the foregoing method, further including requesting, by a client computer, the file container; and indicating, by the client computer, that the file container is complete.

A further embodiment of any of the foregoing methods, further including retrieving, by the data management computer, part data for each of the at least one release record; and adding, by the data management computer, the part data for each of the at least one release record to the file container.

A further embodiment of any of the foregoing methods, wherein the life cycle model includes a plurality of first linkage records stored in the database, and wherein retrieving, by the data management computer, the at least one release record for each of the at least one release set includes retrieving, by the data management computer, the at least one release record for each of the at least one release set based upon each of the first plurality of linkage records that includes a link to the respective one the at least one release set.

A further embodiment of any of the foregoing methods, wherein the life cycle model includes a plurality of second linkage records stored in the database, and wherein retrieving, by the data management computer, the part data for each of the at least one release record includes retrieving, by the data management computer, the part data for each of the at least one release record based upon each of the second plurality of linkage records that includes a link to the respective one of the at least one release record.

A further embodiment of any of the foregoing methods, wherein retrieving, by the data management computer, the part data for each of the at least one release record includes identifying, by the data management computer, a location of the part data within the life cycle model on the database computer; and retrieving, by the data management computer, the part data from the location.

A further embodiment of any of the foregoing methods, wherein the part data is source code configured to implement the product.

A further embodiment of any of the foregoing methods, wherein generating, by the data management computer, the file container includes generating a release set folder for the at least one release set.

A further embodiment of any of the foregoing methods, wherein generating the release set folder comprises generating meta data that includes information regarding the at least one release set.

A further embodiment of any of the foregoing methods, further including transferring the file container from the data management computer to a file server.

A system for automatically retrieving life cycle data of a product includes a database computer and a data management computer. The database computer is configured to store a life cycle model for the product. The data management computer is configured to generate a file container. The file container includes at least one release set and at least one release record for each of the at least one release set. The data management computer is configured to automatically retrieve the at least one release set and the at least one release record from the life cycle model on the database computer.

The system of the preceding paragraph can optionally include, additionally and/or alternatively, any one or more of the following features, configurations, operations, and/or additional components:

A further embodiment of the foregoing system, further including a client computer configured to request the file container from the data management computer and indicate to a user that the file container is complete.

A further embodiment of any of the foregoing systems, wherein the data management computer is further configured to retrieve part data for each of the at least one release record and add the part data for each of the at least one release record to the file container.

A further embodiment of any of the foregoing systems, wherein the life cycle model includes a plurality of first linkage records stored in the database computer, and wherein the data management computer is configured to retrieve the at least one release record for each of the at least one release set based upon each of the first plurality of linkage records that includes a link to the respective one the at least one release set.

A further embodiment of any of the foregoing systems, wherein the life cycle model includes a plurality of second linkage records stored in the database computer, and wherein the data management computer is configured to retrieve the part data for each of the at least one release record based upon each of the second plurality of linkage records that includes a link to the respective one of the at least one release record.

A further embodiment of any of the foregoing systems, wherein the data management computer is further configured to identify a location of the part data within the life cycle model on the database computer and retrieve the part data from the location.

A further embodiment of any of the foregoing systems, wherein the part data is source code configured to implement the product.

A further embodiment of any of the foregoing systems, wherein the data management computer is further configured to generate a release set folder for the at least one release set.

A further embodiment of any of the foregoing systems, wherein the release set includes meta data that includes information regarding the at least one release set.

A further embodiment of any of the foregoing systems, further including a file server, wherein the data management computer is further configured to transfer the file container from the data management computer to the file server.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of automatically retrieving life cycle data of a product, the method comprising:
generating, by a data management computer, a file container;
retrieving, by the data management computer, at least one release set from a life cycle model stored on a database computer;
retrieving, by the data management computer, at least one release record for each of the at least one release set, wherein each of the at least one release record are part of the life cycle model and stored in the database computer; and
adding, by the data management computer, each of the at least one release set and each of the at least one release record to the file container.

2. The method of claim 1, further comprising:
requesting, by a client computer, the file container; and
indicating, by the client computer, that the file container is complete.

3. The method of claim 1, further comprising:
retrieving, by the data management computer, part data for each of the at least one release record; and
adding, by the data management computer, the part data for each of the at least one release record to the file container.

4. The method of claim 3, wherein the life cycle model includes a plurality of first linkage records stored in the database, and wherein retrieving, by the data management computer, the at least one release record for each of the at least one release set comprises:
retrieving, by the data management computer, the at least one release record for each of the at least one release set based upon each of the first plurality of linkage records that includes a link to the respective one the at least one release set.

5. The method of claim 4, wherein the life cycle model includes a plurality of second linkage records stored in the database, and wherein retrieving, by the data management computer, the part data for each of the at least one release record comprises:
retrieving, by the data management computer, the part data for each of the at least one release record based upon each of the second plurality of linkage records that includes a link to the respective one of the at least one release record.

6. The method of claim 3, wherein retrieving, by the data management computer, the part data for each of the at least one release record comprises:
identifying, by the data management computer, a location of the part data within the life cycle model on the database computer; and
retrieving, by the data management computer, the part data from the location.

7. The method of claim 3, wherein the part data is source code configured to implement the product.

8. The method of claim 1, wherein generating, by the data management computer, the file container comprises generating a release set folder for the at least one release set.

9. The method of claim 8, wherein generating the release set folder comprises generating meta data that includes information regarding the at least one release set.

10. The method of claim 1, further comprising transferring the file container from the data management computer to a file server.

11. A system for automatically retrieving life cycle data of a product, the system comprising:
a database computer configured to store a life cycle model for the product;
a data management computer configured to generate a file container, wherein the file container includes at least one release set and at least one release record for each of the at least one release set, and wherein the data management computer is configured to automatically retrieve the at least one release set and the at least one release record from the life cycle model on the database computer.

12. The system of claim 11, further comprising:
a client computer configured to request the file container from the data management computer and indicate to a user that the file container is complete.

13. The system of claim 11, wherein the data management computer is further configured to retrieve part data for each of the at least one release record and add the part data for each of the at least one release record to the file container.

14. The system of claim 13, wherein the life cycle model includes a plurality of first linkage records stored in the database computer, and wherein the data management computer is configured to retrieve the at least one release record for each of the at least one release set based upon each of the first plurality of linkage records that includes a link to the respective one the at least one release set.

15. The system of claim 14, wherein the life cycle model includes a plurality of second linkage records stored in the database computer, and wherein the data management computer is configured to retrieve the part data for each of the at least one release record based upon each of the second plurality of linkage records that includes a link to the respective one of the at least one release record.

16. The system of claim 13, wherein the data management computer is further configured to identify a location of the part data within the life cycle model on the database computer and retrieve the part data from the location.

17. The system of claim 13, wherein the part data is source code configured to implement the product.

18. The system of claim 11, wherein the data management computer is further configured to generate a release set folder for the at least one release set.

19. The system of claim 18, wherein the release set includes meta data that includes information regarding the at least one release set.

20. The system of claim 11, further comprising a file server, wherein the data management computer is further configured to transfer the file container from the data management computer to the file server.
